(19) United States
(12) Patent Application Publication
(10) Pub. No.: US 2013/0166956 A1
(43) Pub. Date: Jun. 27, 2013

(54) DIAGNOSTIC CARD FOR RECORDING REBOOT TIMES OF SERVERS

(71) Applicants: WEI PANG, Shenzhen City (CN); YANG LIU, Shenzhen City (CN); CHENG-FEI WENG, Shenzhen City (CN); AI-LING HE, Shenzhen City (CN)

(72) Inventors: WEI PANG, Shenzhen City (CN); YANG LIU, Shenzhen City (CN); CHENG-FEI WENG, Shenzhen City (CN); AI-LING HE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/597,279

(22) Filed: Aug. 29, 2012

(30) Foreign Application Priority Data
Dec. 23, 2011 (CN) 201110437685.2

(51) Int. Cl. G06F 11/22

(52) U.S. Cl. 714/36; 714/E11.149

(57) ABSTRACT

A diagnostic card includes a circuit board, a connector, a controller, and a first display. The connector is coupled to a low pin count (LPC) to receive a reset signal outputted by a basic input output system as a server reboots. The controller is configured to record the total number of reboot times of the server and displays the total number of reboot times on the first display area.

### BACKGROUND

1. Technical Field

The present disclosure relates generally to diagnostic cards, and more particularly to a diagnostic card for automatically recording the reboot times of a server.

2. Description of Related Art

In the process of producing a server, many tests are employed to determine whether the server is qualified or not, especially tests for the motherboard of the server. A circular reboot test is one of the most important tests, which is employed to determine whether the total number of continuous reboot times reaches a predetermined value, such as 2000. A determination can be made that the server is proved to have great stability if the total number of the continuous reboot times reaches the predetermined value. If it takes 25 seconds to reboot the server each time, the total time for completing 2000 reboots is almost 14 hours, which is difficult to record manually, and the result may be susceptible to human errors.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a diagnostic card of the present disclosure.

FIG. 2 is a circuit diagram of the diagnostic card of FIG. 1.

### DETAILED DESCRIPTION

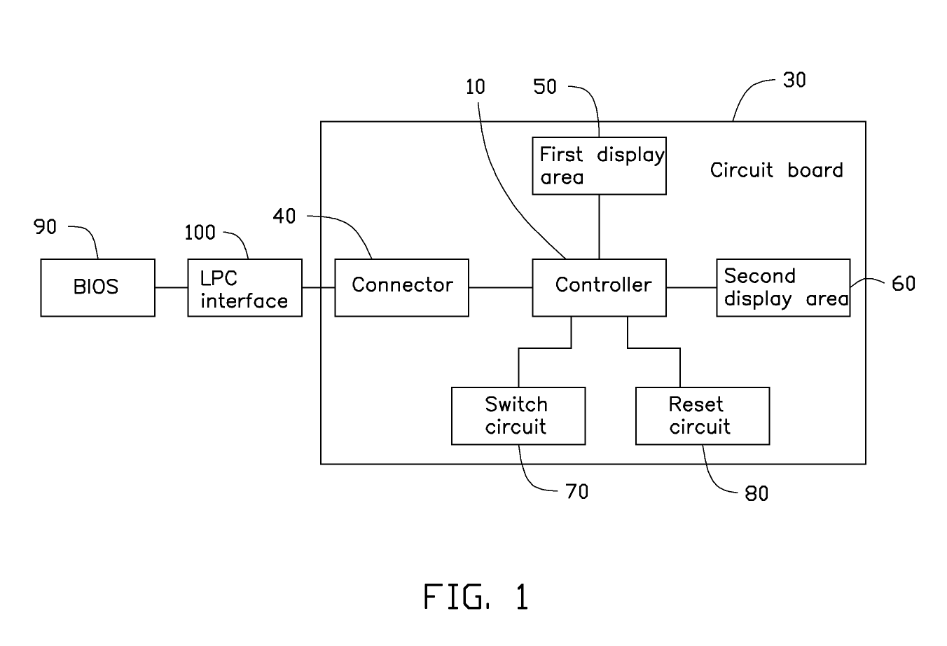

FIG. 1 illustrates an embodiment of a diagnostic card of the present disclosure. The diagnostic card includes a circuit board 30, a controller 10, a connector 40, a first display area 50, a second display area 60, a switch circuit 70, and a reset circuit 80. The controller 10, the connector 40, the first display area 50, the second display area 60, the switch circuit 70, and the reset circuit 80 are all arranged on the circuit board 30.

According to the working principle of a server, a basic input output system (BIOS) 90 arranged on the motherboard of the server will do a power-on self test (POST) as the server is powered on, thereby testing the server's processor, memory, chipset, disk drives, and other crucial components. The BIOS 90 will transmit different POST codes according to the states of all components through a low pin count (LPC) interface 100. The LPC interface 100 includes first to fourth address pins, a frame pin, a clock signal pin, and a reset signal pin. The BIOS also outputs a reset signal with low level, such as logic 0, when the server reboots. Accordingly, the diagnostic card can determine the state of the server by obtaining the POST code that is outputted by the BIOS 90. For example, if the server bootstraps successfully by an operation system (OS), it means that all components of the server are normal, and the BIOS will output an “FF” POST code. The diagnostic card displays the “FF” characters by the first display area 50 after receiving the “FF” POST code. If a memory chip is not properly seated, for example, it means that there exists at least one component of the server being abnormal, the BIOS outputs a “2A” POST code during the POST, and the diagnostic card will display the “2A” characters by the first display area 50 after receiving the “2A” POST code.

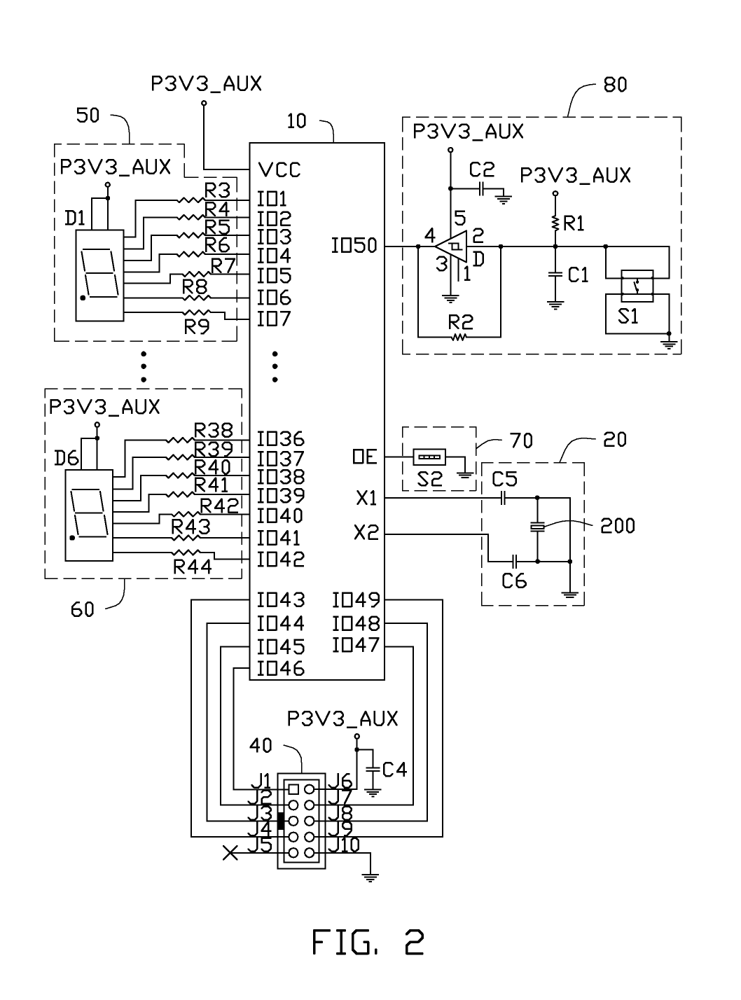

FIG. 2 illustrates a circuit diagram of the diagnostic card of the embodiment. A power pin VCC of the controller 10 is coupled to a power source P3V3_AUX. The controller 10 is configured to receive the POST code outputted by the BIOS 90, and shows the corresponding characters of the POST code on the first display area 50. The controller 10 is also configured to record the reboot times of the server, and displays the total number of the reboot times on the second display area 60. In the embodiment, the first display area 50 includes two seven-segment displays (for simplicity only one is shown), and the second display area 60 includes four seven-segment displays (for simplicity only one is shown). Each seven-segment display includes a power pin, a point pin, and seven data pins. The power pin and the point pin of all the seven-segment displays are coupled to the power source P3V3_AUX. The data pins of all the seven-segment displays are respectively coupled to input output pin 1-42 (IO1-IO42) of the controller 10 respectively through the resistors R3-R44. In the embodiment, the controller 10 is a complex programmable logic device (CPLD), which obtains a work frequency from a crystal oscillator circuit 20. The crystal oscillator circuit 20 includes a crystal oscillator 200, a capacitor C5 and a capacitor C6. First terminal of the capacitors C5 and C6 are respectively coupled to crystal pins X1 and X2 of the controller 10. Second terminal of the capacitors C5 and C6 are both grounded. The crystal oscillator 200 is coupled between the second terminals of the capacitors C5 and C6.

The switch circuit 70 is employed to control the working state of the diagnostic card. The switch circuit 70 includes a switch S2. An enable pin OE of the controller 10 is coupled to a first terminal of the switch S2, and a second terminal of the switch S2 is grounded. When the switch S2 is open, the voltage level of the enable pin OE is high, the state of the controller 10 is changed to the working state. The controller 10 may stop working in response to the switch S2 being closed to make the enable pin OE of the controller 10 grounded.

The connector 40 is used to receive the POST codes outputted by the BIOS 90 through the LPC interface 100. The connector 40 includes first to tenth pins J1-J10. The first to fourth pins J1-J4 are respectively coupled to input output pins IO3-IO46 of the controller 10, to receive data transmitted by the first to fourth address pins of the LPC interface, thereby to transmit the POST codes to the controller 10. The seventh to the ninth pins J7-J9 of the connector 40 are coupled to the input output pin IO47-IO49 of the controller 10, and configured to receive the data transmitted by the clock signal pin, the reset signal pin, and the frame signal pin of the LPC interface, respectively. The fifth pin J5 of the connector 40 is idle, and the tenth pin J10 is grounded. The sixth pin J6 is coupled to the power source P3V3_AUX, and is also grounded through the capacitor C4.

The reset circuit 80 includes a switch S1, two resistors R1 and R2, a Schmitt trigger D, and two capacitors C1 and C2. A power pin 5 of the Schmitt trigger D is coupled to the power source P3V3_AUX, and is also grounded through the capacitor C2. A ground pin 3 of the Schmitt trigger D is grounded. An idle pin 1 of the Schmitt trigger D is idle. An output pin 4 of the Schmitt trigger D is coupled to the input output pin IO50 of the controller 10, and is also coupled to an input pin 2 of the Schmitt trigger D through the resistor R2. The input pin 2 of the Schmitt trigger D is further coupled to the power source P3V3_AUX through the resistor R1, and grounded through the capacitor C1. The input pin 2 of the Schmitt trigger D is also coupled to a first terminal of the switch S1. A second terminal of the switch S1 is grounded. When the switch S1 is closed, the number of the reboot times of the server recorded by the diagnostic card is reset. For example, the number of the reboot times is loaded with 0. Thereafter, the diagnostic card can be used to do the circular reboot test on other servers.

In use, the connector 40 is coupled to the LPC interface 100 of the server, to receive the POST code and the reset signal from the BIOS 90. The connector 40 thereafter delivers the POST code and the reset signal to the controller 10. The controller 10 displays the corresponding characters of the POST code on the first display area 50. For instance, if the server bootstraps successfully by an operation system, the first display area 50 shows the “FF” characters. If the memory chip is not properly seated, for example, the first display area 50 shows the “2A” characters. The controller 10 is configured to record the reboot times of the server by increasing 1 as receiving one reset signal with low level, and displays the total number of the reboot times on the second display area 60.

The total number of the reboot times is reset as the switch S1 being closed.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A diagnostic card for a server, comprising:
a connector coupled to a low pin count (LPC) interface to receive a reset signal outputted by a basic input output system (BIOS) of the server;
a controller configured to record the total number of reboot times of the server, wherein the controller increases the total number of the reboot times of the server by 1 after receiving one reset signal; and
a first display area configured to display the total number of reboot times.

2. The diagnostic card of claim 1, further comprising:
a second display area, wherein the controller is configured to obtain a power-on self test (POST) code outputted by the BIOS, the second display area displays corresponding characters of the POST code.

3. The diagnostic card of claim 1, wherein the controller is a complex programmable logic device (CPLD).

4. The diagnostic card of claim 3, further comprising:
a crystal oscillator circuit providing a working frequency for the CPLD, wherein the crystal oscillator circuit includes a first capacitor, a second capacitor, and a crystal oscillator, first terminals of the first capacitor and the second capacitor are respectively coupled to two crystal pins of the CPLD, second terminals of the first and the second capacitors are grounded, the crystal oscillator is coupled between the second terminals of the first and the second capacitors.

5. The diagnostic card of claim 1, further comprising:
a switch circuit configured to control the working state of the diagnostic card, wherein the switch circuit includes a first switch, a first terminal of the first switch is coupled to an enable pin of the controller, a second terminal of the first switch is grounded.

6. The diagnostic card of claim 1, further comprising:
a reset circuit, wherein the reset circuit includes a Schmitt trigger, a first resistor, and a second switch, a power pin of the Schmitt trigger is coupled to a power source, a ground pin of the Schmitt trigger is grounded, an idle pin of the Schmitt trigger is idle, an output pin of the Schmitt trigger is coupled to a first input output pin of the controller, and further coupled to an input pin of the Schmitt trigger through the first resistor, the input pin of the Schmitt trigger is grounded through the second switch.

7. The diagnostic card of claim 6, wherein the reset circuit further includes a second resistor, a third capacitor, and a fourth capacitor, the power pin of the Schmitt trigger is grounded through the third capacitor, the input pin of the Schmitt trigger is coupled to the power source through the second resistor, and grounded through the fourth capacitor.

8. The diagnostic card of claim 1, wherein the first display area includes first to fourth seven-segment displays, each of the first to fourth seven-segment displays includes a power pin, a point pin, and seven data pins, the power pin and the point pin of the first to fourth seven-segment displays are coupled to a power source, each data pin of the first to fourth seven-segment displays is coupled to an input output pin of the controller through a resistor.

9. The diagnostic card of claim 8, further comprising:
a second display area, wherein the controller is configured to obtain a power-on self test (POST) code outputted by the BIOS, the second display area displays corresponding characters of the POST code.

10. The diagnostic card of claim 9, wherein the second display area includes a sixth seven-segment display and a seventh seven-segment display, a power pin and a point pin of the sixth and the seventh seven-segment displays are coupled to the power source, and each data pin of the six and the seventh seven-segment displays is coupled to an input output pin of the controller through a resistor.

11. The diagnostic card of claim 1, wherein the connector and the controller are arranged on a circuit board.
